(19) United States
(12) Patent Application Publication
(10) Pub. No.: US 2018/0238062 A1
(43) Pub. Date: Aug. 23, 2018

(54) DECORATIVE SURFACE COVERING INCLUDING UNIFORM DENSITY STRAND BOARD

(71) Applicant: AFI Licensing LLC, Lancaster, PA (US)

(72) Inventors: Travis E. Bjorkman, Lancaster, PA (US); Brian W. Beakler, York, PA (US)

(73) Assignee: AFI Licensing LLC, Lancaster, PA (US)

(21) Appl. No.: 15/902,327

(22) Filed: Feb. 22, 2018

Related U.S. Application Data
(60) Provisional application No. 62/462,609, filed on Feb. 23, 2017.

(51) Int. Cl. E04F 15/04; B32B 7/12; B32B 21/02; B32B 37/12; B32B 3/06; B27N 3/04; B27N 3/18; E04F 15/02

(52) U.S. Cl. CPC E04F 15/04; B32B 7/12; B32B 21/02; B32B 37/12; B32B 2419/04; B27N 3/04; B27N 3/18; E04F 15/02038; B32B 3/06

(57) ABSTRACT

A surface covering including a uniform density strand board and a top layer, where the top layer, which can include a decorative surface is adhered to the strand board. This surface covering is useful in an engineered flooring construction.

### BACKGROUND OF THE INVENTION

### Field of the Invention

The invention includes a surface covering, such as a decorative surface covering, which includes a uniform density strand board and a top layer. This surface covering is useful in an engineered flooring construction.

### Summary of Related Art

Plywood, medium density fiberboard (MDF), and high density fiberboard (HDF) are commonly used materials for engineered surface coverings, such as flooring. Traditional oriented strand board (OSB) has typically not been well-received in the marketplace as a core for a flooring product.

### SUMMARY OF THE INVENTION

The marketplace seeks surface coverings, such as flooring products, which provide new and improved benefits, without deficiencies of prior products. Traditional OSB has some concerns where formaldehyde may be included as a binder, where pine was included as the strand, an odor in the product. Another concern is the density variation of the material, where the innermost portion of the board has a lower density making it difficult to machine causing an inability to provide a tight connection between panels or tiles. For example, when a tongue and groove connection is used, deformation of the tongue may occur, making the connection of panels difficult or impossible. Another downside of traditional OSB as a surface covering is the telegraphing of strands to the surface, which provides an uneven appearance.

These issues have been overcome by surface coverings that include a uniform density strand board with a top layer. The surface covering may also have a bottom layer and form tiles, planks, panels or any other suitable configuration. A connection point can also be included, such as a tongue and groove or a locking profile to permit joining of adjacent panels or tiles. Many examples of locking profiles are known in the art.

A process for preparing a surface covering, such as flooring, is provided which includes (a) providing a uniform density strand board; (b) providing a top layer; and (c) adhering the uniform density strand board to the top layer. The uniform density strand board may be prepared by providing a heat source, combining wood strands with a resin, forming sheets and pressing the sheets. The orientation of strands may vary because the surface covering is not required to be structural. The surface covering itself may be solely decorative, structural, or non-structural. Suitable orientations include a random orientation, an aligned orientation, and a cross orientation (where strands are oriented at 90° angles to each other. A random orientation of strands may increase dimensional stability, which is important for floor coverings.

### DETAILED DESCRIPTION OF THE INVENTION

### Definitions

The term “Uniform Density Strand Board” is meant to include a composite engineered wood product including layers of wood strand, binder, and optionally other components, such as adhesives or waxes, having a homogenous vertical density profile. The density of the core of the board is greater than 50% of the highest surface density. Suitable examples of the core density include those that are about 75% to about 100% of the highest surface density and where the core density is about 85% or greater or 90% or greater than the highest surface density. A suitable variation in the density is about 25% or less throughout the thickness of the board.

The term “strand” is meant to include wood strands in any form. This includes flakes, chips, particles, wafers, and combinations thereof. The terms strand, flake, chip, particle, and wafer will be used interchangeably to refer to these wood components.

A variety of strand shapes and sizes are useful for the uniform density strand board. They may have a length/width of about 20 mils to about 10 in, such as about 0.1 in to about 5 in and a thickness of about 10 mils to about 50 mils, including about 25 mils to about 35 mils with a typical thickness being about 30 mils.

The species of the strands may also vary to include either hardwood, softwood, or a combination of different species. Non-limiting examples of suitable hardwood species include Aspen, poplar, hickory, maple, oak, beech, and ash, among others. Typically, Aspen and or poplar may be included as the primary or sole species. Non-limiting examples of suitable softwood species include pine, fir, spruce, cedar, and combinations thereof.

The moisture content of the strand whether depends on whether such wood is dry (having a moisture content of about 1 wt % to about 25 wt %) or green (having a moisture content of about 25 wt % to about 200 wt %).

The top layer can be any decorative surface. This can include a veneer, a decorative veneer, a coating, paper, printing, and combinations thereof. Such top layers are well-known in the art, especially in the flooring industry.

The bottom layer may be present on a bottom surface of the uniform density strand board. Where the bottom layer is included, it would be between a surface of the strand board and a subfloor. Suitable bottom layers include, but are not limited to, a veneer, a coating, paper, cork, foam, underlayment, and combinations thereof.

Either of the top and/or bottom layer may be adhered to the strand board by an adhesive. Any suitable adhesive may be included. Suitable adhesives include those selected from the group consisting of polyvinyl acetate, urea formaldehyde, acid-catalyzed phenolic resin, methylene diphenylene isocyanate (MDI), and combinations thereof. Any of the resins useful as the binder may also be used as the adhesive.

The density of the uniform density strand board can vary depending on the desired properties. Suitable densities include about 20 to about 60 pounds per cubic foot (pcf), such as about 32 to about 50 pcf, and about 37 to about Regardless of the density, the board will have substantially the same density throughout its thickness, unlike waferboard or oriented strand board, which have a higher density on the faces and a lower density in the core. The thickness of the board may also vary depending on the desired properties. A suitable range of thickness is about 0.1 in to about 2.0 in. This includes about 0.2 in to about 0.8 in., and about 0.3 in to about 0.5 in.

Various polymeric resins, such as thermosetting resins, may be employed as binders for the wood flakes or strands. Suitable polymeric binders include isocyanate resin, urea-formaldehyde, polyvinyl acetate (“PVA”), phenol formaldehyde, melamine formaldehyde, melamine urea formaldehyde (“MUF”) and the co-polymers thereof. Isocyanates may be preferred where providing a formaldehyde-free product is desired. Isocyanates may be selected from the diphenylmethane-p,p′-diisocyanate group of polymers, which have NCO-functional groups that can react with other organic groups to form polymer groups such as polyurea (—NCON—), and polyurethane, (˜NCOO—); a binder with about 50 wt % 4,4-diphenylmethane diisocyanate (“MDI”) or in a mixture with other isocyanate oligomers (“pMDI”) may be included. A suitable commercial pMDI product is Rubinate 1840 available from Huntsman, Salt Lake City, Utah and Mondur 541 available from Bayer Corporation, North America, of Pittsburgh, Pa. Suitable commercial MUF binders are the LS 2358 and I S 2250 products from the Dynea Corporation.

The binder loading level is about 2 wt % to about 15 wt %, including about 3 wt % to about 8 wt %, and about 4 wt % to about 6 wt % of the weight of the oven-dried wood strands.

A wax additive may be employed to enhance the resistance of the panels to moisture absorption and penetration. Examples of waxes are slack wax, emulsion wax or a combination of both. A suitable range for wax solids loading level is in the range of about 0.1 wt % to about 3.0 wt % (based on the oven-dried wood weight).

Typical moisture content for the uniform density strand board is about 1 wt % to about 20%, such as about 6% to about 15% or about 3 to about 12%. However, the moisture content may vary and a range of different moisture contents may be suitable.

After the strands are cut they are dried in an oven and then coated with a desired amount of one or more polymeric thermosetting binder resins, waxes and other additives. The binder resin and the other various additives that are applied to the wood materials are referred to herein as a coating, even though the binder and additives may be in the form of small particles, such as atomized particles or solid particles, which do not form a continuous coating upon the wood material. The binder, wax and any other additives may be applied to the wood materials by any suitable method as known in the art, such as by one or more spraying, blending or mixing techniques. One method is to spray the wax, resin, and other additives upon the wood strands as the strands are tumbled in a drum blender. The coated strands are used to prepare the wood panels.

The uniform density of the strand board may be achieved through processes shown in U.S. Pat. No. 7,658,873 B2, which is incorporated herein by reference in its entirety. One feature of the process is a pre-heating procedure used with a conventional OSB production line to raise the temperature of the strands before they are consolidated into the final product. The range of the pre-heating temperature may be from about 35° C. up to the onset temperature of the particular adhesive or resin used in the product. After the pre-heating procedure, the softened strands in the core layer are easier to densify. As a result, the relatively high density in the surface compared to the core can be reduced or even eliminated. The preheating process can be applied by any heat source, such as by microwave, radio frequency (RF) or high frequency irradiation, infrared irradiation, hot air, or steam, to raise the strands temperature. Any method of heat transfer, such as conduction, convection or radiation may be used. The preheating process can be applied in any location in the production line before the final consolidation, such as heating the strands during the blending process, heating the mat during the mat formation, heating the mat after the mat formation but before the consolidation, or heating the mat before the final stage of the consolidation. Because the target of the pre-heating step are the strands in the core layer, the heating area of the OSB strands or mat can be either the entire mat or only the core zone, where a surface/core/surface configuration is prepared.

A panel of the uniform density strand board may be prepared by combining the pre-heating step with a conventional manufacturing process for relevant to composite engineered wood panels. For example, an illustrative process for manufacturing the panel is described below. A composite engineered wood product generally has multiple layers of wood flakes or strands bonded together by a resin binder.

In general, the process includes preparing the uniform density strand board by providing a heat source, combining wood strands with a resin, forming sheets and pressing the sheets. The wood strands should be preheated, as described herein. Either a continuous press or batch process may be used for pressing the sheets. A multiple opening press may also be useful. The roller temperature for pressing the sheets may have a temperature of about 380° F. to about 430° F. is used. Any suitable heat source may be used such as those selected from the group consisting of steam, microwave, and combinations thereof.

The flakes may be prepared by cutting logs into thin slices with a knife edge parallel to the length of a debarked log. The cut flakes are broken into narrow strands generally having lengths oriented parallel to the wood grain that are larger than the widths. One of ordinary skill in the art can determine the appropriate size of flakes/strands for a particular application. Various methods and equipment for debarking, flaking/stranding, and sizing are known to one of ordinary skill in the art.

Flakes including the coated flakes or coated strands are then spread on a conveyor belt to provide a first surface ply or layer having flakes oriented, as desired, either randomly or generally in line with the conveyor belt. One or more plies that will form an interior ply or plies (core layer(s)) of the finished board is (are) deposited on the first ply such that the one or more plies is (are) oriented, as desired, either randomly or generally perpendicular to the conveyor belt. Then, another surface ply having flakes oriented, as desired, such as randomly or generally in line with the conveyor belt is deposited over the intervening one or more plies having flakes oriented generally perpendicular to the conveyor belt. Plies built-up in this manner have flakes oriented generally perpendicular or a neighboring ply insofar as each surface ply and the adjoining interior ply. Alternatively, one of ordinary skill in the art can determine other orientations for the strands in the layers, e.g., parallel or random. One of ordinary skill in the art can determine the appropriate thickness of each layer, appropriate number of layers, and appropriate composition for each layer to use for a particular application. Various methods and equipment for forming, orienting, and conveying the layered mat are known to one of ordinary skill in the art.

The layers of “strands” or “flakes” are finally exposed to heat and pressure to bond the strands and binder together (consolidate and cure). The resulting product is then cut to size and shipped. One of ordinary skill in the art can determine the appropriate consolidation ru1d curing to use for a particular application, e.g., cold press and UV or microwave cure. Various methods and equipment for consolidating and curing the layered mat are known to one of ordinary skill in the art.

Hardwood and softwood can be separated during processing (e.g., debarking, stranding, drying, blending, and forming). This can facilitate control over the amount of each type of wood and its location in a panel. The strand/flake moisture content (pre-pressing moisture) can be adjusted, for example, by amount of drying, water spray in the blender, water spray in the forming line, or combinations thereof. Various methods and equipment for separation and flake moisture addition or removal are well-known.

After the uniform density strand board is obtained, it will be combined with additional layers including at least one top layer. An adhesive can be employed. This can be achieved with either a cold or hot press, and in either a continuous press or batch process.

The features and advantages of the present invention are more fully shown by the following examples which are provided for purposes of illustration, and are not to be construed as limiting the invention in any way.

### Examples

### Preparation of Uniform Strand Board

Aspen strands having a length within a range of 5-5.75″. a width within a range of 0.5-1 in and a thickness within a range of 0.015″-0.020″ were used as the raw material. Seven weight percent of MDI (diphenylmethane diisocyanate) was applied as the binder to these strands when they tumble with the blender by means of a spinning disc. After blending, the coated strands were formed into a mat similar to conventional OSB 3-layer orientation. The mat was pre-heated by microwave irradiation for 28 seconds until the core temperature in the mat was raised to 53° C. The pre-heated mat then was pressed with the hydraulic press at a temperature of 200° C. for a period of 6 minutes. The thickness of the panel was 0.72 inches and the average density was targeted at 30 pcf.

### Preparation of the Surface Covering

Two strand boards as described above was obtained having a thickness of 9 mm. The top surface of the board was sanded to have a marbled appearance and the bottom surface was fully sanded. The top layer was a 2 mm thick hickory wood veneer for the first board and a 2 mm oak wood veneer for the second board. Each veneer was adhered to a strand board using a Titebond® II PVA adhesive applied with a H nap roller. The boards were each pressed in a cold press to provide a surface covering. The surface covering was ripped into five inch wide strips, which were machined with a router to provide a tongue and groove connection.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

1. A surface covering comprising:
(a) a uniform density strand board and
(b) a top layer.

2. The surface covering of claim 1, further comprising a bottom layer.

3. The surface covering of claim 1, wherein the surface covering is a panel.

4. The surface covering of claim 3, wherein said panel includes edges having a connection point.

5. The surface covering of claim 4, wherein the connection point includes a tongue and groove configuration or a locking profile.

6. The surface covering of claim 1, wherein the surface is a subfloor.

7. The surface covering of claim 1, wherein said top layer is selected from the group consisting of a veneer, a decorative veneer, a coating, paper, and combinations thereof.

8. The surface covering of claim 2, wherein said bottom layer is selected from the group consisting of a veneer, a coating, paper, cork, foam, underlayment, and combinations thereof.

9. The surface covering of claim 1, wherein the uniform density strand board is bonded to the top layer with an adhesive.

10. The surface covering of claim 9, wherein said adhesive is selected from the group consisting of polyvinyl acetate, urea formaldehyde, acid-catalyzed phenolic resin, methylene diphenylene isocyanate (MDI), and combinations thereof.

11. The surface covering of claim 1, wherein said uniform density strand board comprises wood strands and a resin.

12. The surface covering of claim 11, wherein said resin is selected from the group consisting of methylene dipheneylene isocyanate (MDI), phenol formaldehyde, melamine fortified urea formaldehyde (MUF), and combinations thereof.

13. The surface covering of claim 11, wherein said wood strand is selected from the group consisting of pine, poplar, yellow poplar, Aspen, maple, other hardwood species, and combinations thereof.

14. The surface covering of claim 11, wherein said wood strands are randomly oriented.

15. The surface covering of claim 1, wherein said surface covering is decorative or non-structural.

16. The surface covering of claim 1, wherein said uniform density strand board has a low density.

17. The surface covering of claim 16, having a thickness wherein said uniform density strand board had a density within 25% of a target density throughout the thickness.

18. A process for preparing a surface covering comprising:
(a) providing a uniform density strand board;
(b) providing a top layer; and
(c) adhering said uniform density strand board to said top layer.

19. The process of claim 18, wherein said uniform density strand board is prepared by providing a heat source, combining wood strands with a resin, forming sheets and pressing the sheets.

20. The process of claim 19, wherein said wood strands and resin are preheated before pressing.

21. The process of claim 19, wherein a continuous press or batch process is used for pressing sheets.

22. The process of claim 21, wherein a multiple opening press is used.

23. The process of claim 21 wherein a roller having a temperature of about 380° F. to about 430° F. is used for pressing the sheets.

24. The process of claim 19, wherein said heat source is selected from the group consisting of steam, microwave, and combinations thereof.
